(19) United States
(12) Patent Application Publication
(10) Pub. No.: US 2006/0061134 A1
(43) Pub. Date: Mar. 23, 2006

(54) CONNECTOR HAVING AN INTEGRATED GASKET AND METHOD OF MAKING THE SAME

(76) Inventors: Aaron M. DeLong, Oxford, MI (US); Roger Wayne Catron, Washington, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/711,478

(22) Filed: Sep. 21, 2004

(51) Int. Cl. B60J 5/00

(52) U.S. Cl. 296/146.7

(57) ABSTRACT

A connecting member for securing an interior trim assembly to a support of an automobile. The connecting member includes a connector body having a first end adapted to couple to the trim assembly and a second end adapted to couple to the vehicle support, and a sealing gasket integrally molded onto the connector body. Preferably, the connector body has a first hardness and the sealing gasket has a second hardness relatively lower than the first hardness to form a tight seal between the connecting member and the vehicle support. A two-shot molding process may be used to form the connecting member with the connector body being formed in the first shot of the molding process and the sealing gasket being formed in the second shot of the molding process.

### FIELD OF THE INVENTION

The present invention relates generally to automotive interiors, and more particularly, to a connector for securing various trim assemblies to the automotive interior.

### BACKGROUND OF THE INVENTION

It is known to provide automotive interiors with various trim assemblies to improve the aesthetic appearance of the automotive interior and for the comfort and convenience of vehicle occupants. Examples of these interior trim assemblies include instrument panels, armrests, door trim, door scuffs, and consoles. The trim assemblies typically comprise a relatively rigid substrate member having a front surface facing the interior of the vehicle and a back surface opposite the front surface adapted to face a vehicle support member. The rigid substrate provides structural support for the trim assembly and defines the general shape of the trim assembly. Many trim assemblies further include a cover member of leather, cloth, or vinyl disposed over the front surface of the rigid substrate to provide a soft touch and aesthetically pleasing appearance to the interior of the vehicle.

In order to secure the trim assemblies to the vehicle, connecting members are often attached to the back surface of the rigid substrate. These connecting members typically include one or more projections adapted to pass through an aperture in a complementary connecting member on the vehicle support member so as to secure the trim assembly thereto. These types of two-piece connections, however, often require that a seal be formed between the two connecting members. To seal the connection, automotive manufacturers will typically place a foam gasket around the projections of the connecting member which, when attached to the complementary connecting member on the vehicle support, supposedly creates a tight seal. To this end, the gaskets are typically cut from a flat sheet of foam stock material and are coated with an adhesive on one surface for coupling to the connecting member. The gasket is then manually placed over the projections with the adhesive surface in contact with the connecting member.

One drawback of this type of modular arrangement is that the foam gasket may not provide an effective seal with the connecting member, especially when the surface of the connecting member to which the gasket adheres is irregular or otherwise not matching the generally planar surface of the gasket. This mismatch in contours may permit air, dust, moisture, and other contaminants to pass through gaps often created at the gasket/connecting member interface and eventually into the interior of the automobile. These contaminants may lead to occupant discomfort or eventually to the deterioration of the vehicle, such as through rusting. Furthermore, the gaps created at the gasket/connecting member interface may expose the interior of the automobile to increased road, engine and vibration based noises. These noises tend to irritate the vehicle's occupants as conversation, listening to music, and other audio activities inside the vehicle become difficult.

Another drawback of the modular arrangement is that conventional methods for producing connecting members with foam gaskets are manufacturing intensive, requiring multiple operations, multiple parts, and manual labor to produce the desired end product. The increased operations, parts, and manual labor of this process contribute to increased manufacturing costs of the various trim assemblies.

Therefore, a need exists for a connecting member having a sealing gasket that addresses these and other drawbacks of the conventional connections between an automotive trim assembly and a vehicle support.

### SUMMARY OF THE INVENTION

The present invention provides a connecting member having an integrated gasket and method of making the same that secures a trim assembly to an automobile and produces an effective seal between the connecting member and a vehicle support member. The connecting member may be used to secure an instrument panel, armrest, door trim, door scuff, console, or any other trim assembly to the automobile. The connecting member is made through a streamlined manufacturing process that reduces the number of parts and labor associated with conventional connecting members, thus reducing the overall manufacturing cost of the trim assembly.

The connecting member comprises a connector body having a first end adapted to couple to the trim assembly and a second end adapted to couple to the vehicle support. The connecting member further includes a sealing gasket integrally molded with the connector body and adapted to form a tight seal between the connecting member and the vehicle support when the trim assembly is mounted to the automobile.

In one embodiment of the invention, the connector body has a first hardness and the sealing gasket has a second hardness that is relatively lower than the first hardness. For example, the connector body may be formed from a variety of thermoplastic materials, such as polypropylene. The sealing gasket may be formed from a softer material, such as a thermoplastic elastomer. In this way, as the connector body passes through an aperture of a complementary connecting member on the vehicle support member, the sealing gasket is compressed to provide a tight seal between the connecting member and the vehicle support.

A trim assembly may be formed incorporating the above-described connecting member. To this end, the connecting member may be formed from a two-shot molding operation. A first curable material is injected into a mold during a first shot of the molding process to form the connector body. A second curable material is then injected into the mold during a second shot of the molding process to form the sealing gasket on the connector body. In this way, the contour of the sealing gasket conforms to the interfacing surface of the connector body to which it is integrally molded. Consequently, gaps at the gasket/connector body interface are eliminated. The connecting member having the integrated gasket may then be coupled to the substrate of the trim assembly. The trim assembly may subsequently be quickly and conveniently installed to the interior of the automobile.

In another embodiment of the invention, the connecting member may be integrally formed with the substrate of the trim assembly. For example, the substrate and connector body may be integrally formed during the first shot of the molding process. The sealing gasket may then be formed on the connector body during the second shot of the molding process.

These and other objects and advantages of the present invention shall be made apparent from the accompanying drawings and the descriptions thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an automobile door having an exemplary automotive trim assembly;

FIG. 2 is a perspective view similar to FIG. 1 showing the trim assembly removed from the automobile door;

FIG. 3 is a perspective view of a connecting member according to the present invention;

FIG. 4 is a perspective view of the connecting member of FIG. 3 coupled to the trim assembly shown in FIGS. 1 and 2;

FIG. 4A is a partial perspective view of an alternate embodiment of the invention with the connecting member and substrate integrally molded as a unitary structure; and

FIGS. 5A-D sequentially illustrate a two-shot molding operation used to form the connecting member of FIG. 3.

### DETAILED DESCRIPTION

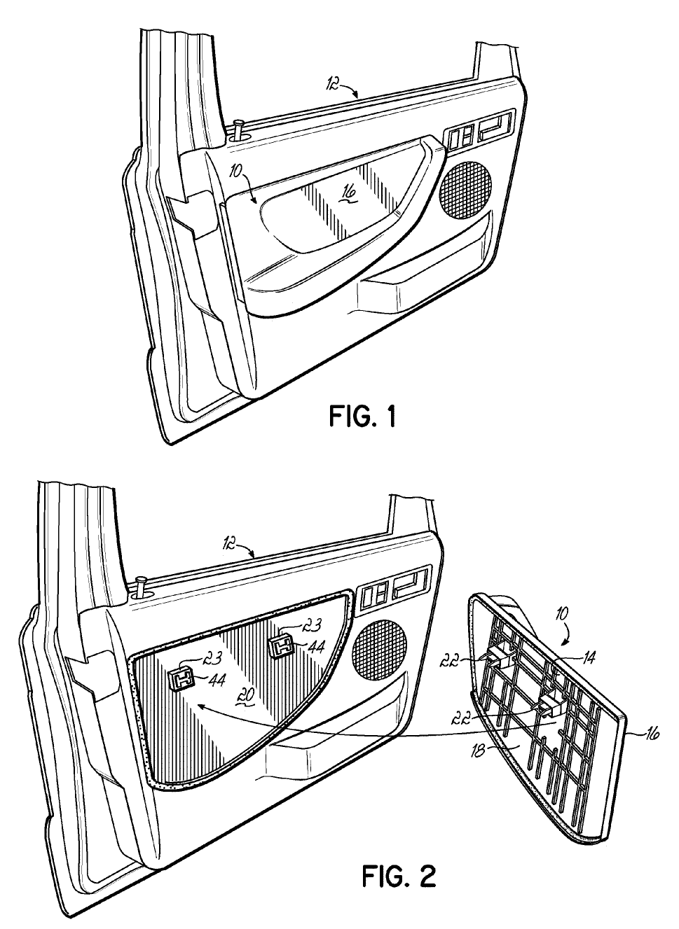

With reference to FIG. 1, an exemplary trim assembly, such as a section of door trim 10, is mounted on the interior side of an automobile door 12 to improve the aesthetic appearance of the automotive interior and for the comfort and convenience of vehicle occupants. As shown in FIG. 2, the door trim 10 includes a relatively rigid substrate member 14, which generally provides structural support for the trim assembly. The substrate member 14 includes a front surface 16 that faces the interior of the automobile and a back surface 18 opposite the front surface 16 that is hidden from view when the door trim 10 is mounted to the automobile. For economy cars, the front surface 16 of the rigid substrate member 14 may include a decorative design, such as a grained or textured pattern formed directly in the front surface 16. For more luxury-oriented cars, however, a cover member of leather, cloth, or vinyl may be disposed over the front surface 16 of the substrate member 14 to provide a soft touch and aesthetically pleasing appearance to the door trim 10.

The door trim 10 is typically secured to a vehicle support member 20 by one or more connecting members, generally shown at 22, that are coupled to the back surface 18 of the rigid substrate member 14, as will be discussed in greater detail below. The connecting members 22 may be received within complementary connecting members 23 on the vehicle support 20 to secure the trim assembly to the automobile. Various other trim assemblies may be generally secured to the automobile in a similar fashion. Thus, although the following detailed description will be directed toward a connecting member for securing door trim, those having ordinary skill in the art will recognize that the invention may equally apply to other trim assemblies in the automobile, such as door scuffs, consoles, instrument panels, and other interior trim assemblies.

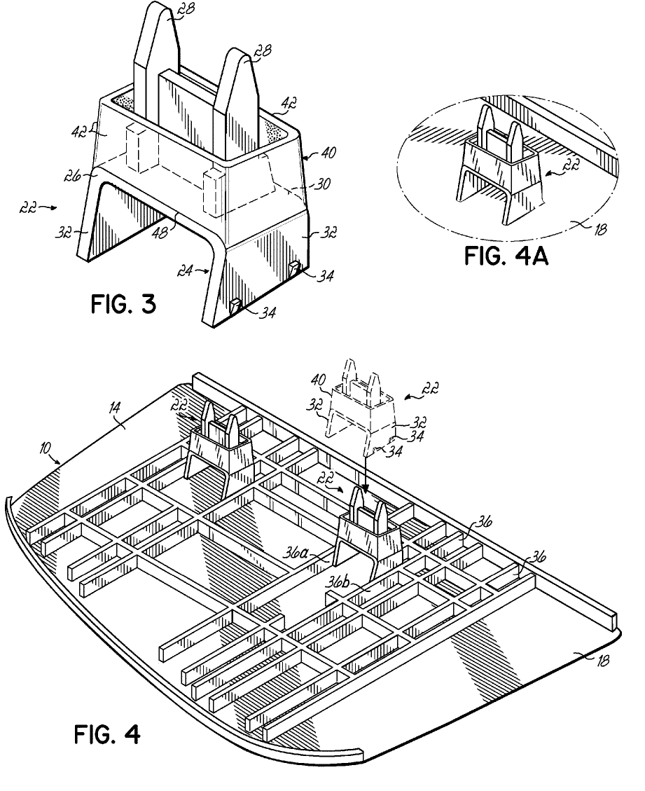

Referring to FIGS. 3-4, a connecting member 22 comprises a connector body 24 having a base member 26 and at least one projection, and preferably two projections 28, extending outwardly from the base member 26. In one embodiment, the base member 26 has a platform surface 30 supported by opposed side flanges 32. The platform surface 30 is generally rectangular, with the projections 28 extending therefrom. The side flanges 32 extend downwardly from the platform surface 30 and may include one or more barbs 34 extending outwardly from the side flanges 32. The barbs 34 and side flanges 32 are configured to frictionally secure the connecting member 22 to the back surface 18 of the rigid substrate member 14. For instance, the back surface 18 of substrate member 14 may include a plurality of blades 36 adapted to receive the side flanges 32 of connecting member 22. In this way, as the connecting member 22 is pushed down between adjacent blades 36a, 36b, the barbs 34 engage and bite into the blades 36a, 36b to frictionally secure the connecting member 22 into place on the substrate member 14.

The invention is not limited to the above-described structure and connection to the substrate member 14 as those of ordinary skill in the art will recognize other connecting member configurations and ways to couple the connecting member 22 to the substrate 14, all within the scope of the invention. For example, as shown in FIG. 4A, in which like reference numerals refer to like features in FIG. 4, the connecting member 22 and substrate member 14 may be integrally formed, such as by integrally molding the connector body 24, as described above, and substrate 14 to form a unitary structure. This advantageously provides a reduction in the number of parts for the trim assembly and a reduction in the labor required to assemble the trim assembly.

To create an effective seal between the connecting member 22 and vehicle support 20, the connecting member 22 further includes a sealing gasket, generally shown at 40, that is integrally molded with the connector body 24. In the embodiment shown in FIG. 3, the sealing gasket 40 comprises a series of walls 42 of relatively uniform thickness that project away from the periphery of the platform surface 30, thereby forming a generally rectangular enclosure around the projections 28.

Referring back to FIG. 2, the connecting members 22 are used to secure the door trim 10 to the vehicle support member 20 on the automobile door 12. As the door trim 10 is pressed against the interior side of the automobile door 12, the projections 28 pass through an aperture 44 on the complementary connecting members 23. The projections 28 and complementary connecting members 23 cooperate to secure the trim assembly to the vehicle support member 20. Furthermore, the walls 42 of the sealing gasket 40 engage the aperture 44 on the complementary connecting members 23 as the door trim 10 is pressed toward the vehicle support 20. In this way, when the door trim 10 is mounted to the vehicle support 20, the sealing gasket 40 is compressed to provide a tight seal around the aperture 44.

A variety of materials may be used to form the sealing gasket 40 and connector body 24. In an exemplary embodiment, the connector body 24 has a first hardness and the sealing gasket 40 has a second hardness that is less than the first hardness. For example, the connector body 24 may be formed from polypropylene and the sealing gasket 40 may be formed from a thermoplastic elastomer. The connecting member 22 of the invention is advantageous in that by integrally molding the sealing gasket 40 to the connector body 24, no gaps are formed along the gasket/connector body interface, generally shown in FIG. 3 at 48. Consequently, contaminants are prevented from passing through the area where the sealing gasket 40 meets the connector body 24. Moreover, the integral nature of the sealing gasket 40 and connector body 24 helps prevent various road, engine, and other external noises from entering the interior of the automobile.

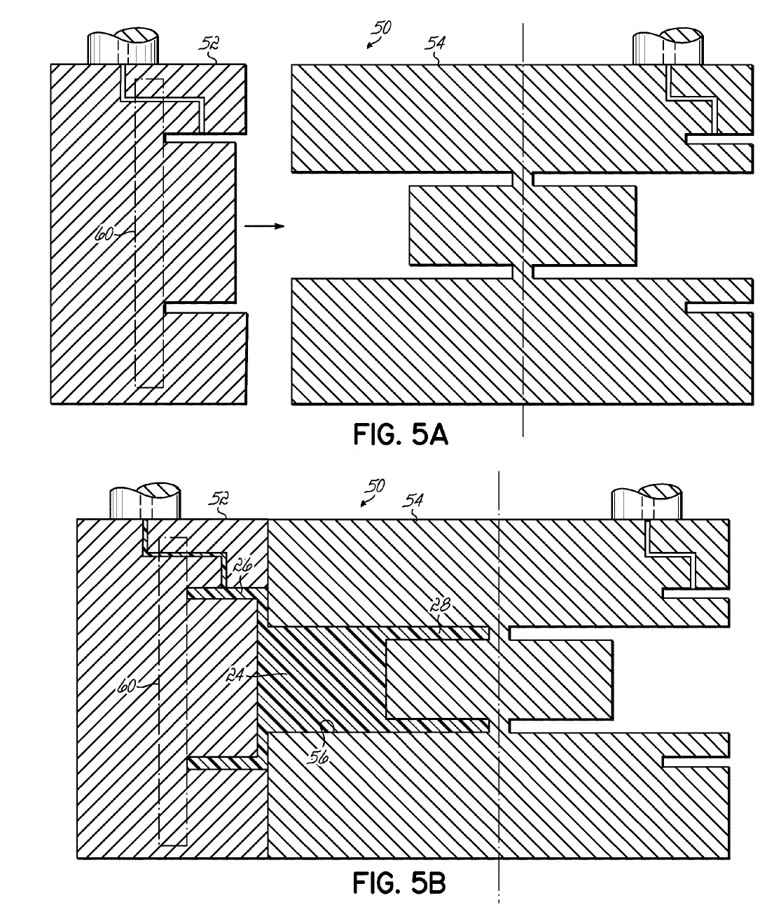

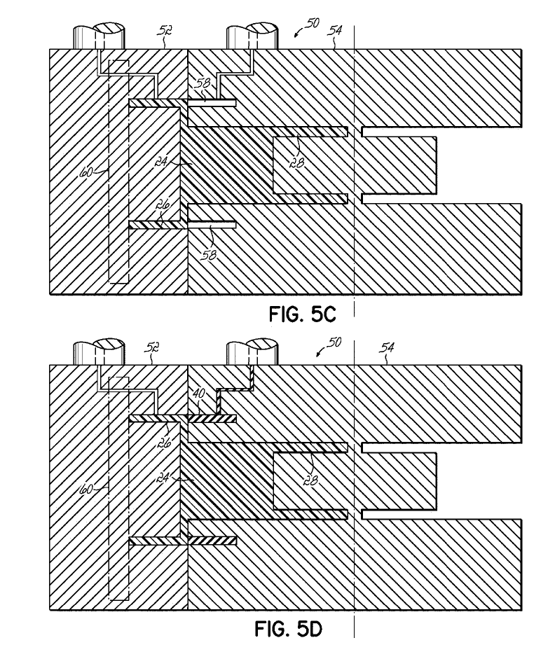

A method of making the connecting member 22 will now be described. With reference to FIGS. 5A through 5D, the connecting member 22 may be formed in a two-shot molding operation. As shown in FIGS. 5A and 5B, a mold, generally shown at 50, comprises first and second mold portions 52, 54 which may be assembled together to define an interior cavity 56 having the general shape of the connector body 24. To this end, the connector body 24 is formed during the first shot of the two-shot molding operation by injecting a first curable material into the mold 50 to integrally form the base member 26 and projections 28. As shown in FIGS. 5B and 5C, after the first curable material is injected into the mold 50 to form the connector body 24, the second mold portion 54 may be rotated such that the first and second mold portions 52, 54 now define a cavity 58 for forming the sealing gasket 40. In alternate embodiments, the second mold portion 54 may be removed and replaced with a third mold portion (not shown) which is configured such that the first and third mold portions define a cavity for forming the sealing gasket 40. As shown in FIG. 5D, a second curable material is injected into the cavity 58 during the second shot of the two-shot mold operation to form the sealing gasket 40 on connector body 24. The finished connecting member 22 having the sealing gasket 40 integrally molded to the connector body 24 is thereafter removed from the mold 50 where it is subsequently coupled to the substrate member 14 of a trim assembly, such as the door trim 10, and coupled to the interior of the automobile as previously described.

The second curable material has a hardness that is relatively lower than the hardness of the first curable material. For example, the first curable material injected into the mold 50 may be polypropylene and the second curable material injected into the mold 50 may be a thermoplastic elastomer. The relatively lower hardness of the second curable material enables the sealing gasket 40 to form a tight seal between the connecting member 22 and vehicle support 20.

The embodiment shown in FIG. 4A, in which the substrate member 14 and the connecting member 22 are integrally formed, may also be formed in a two-shot molding process similar to that described above. To this end, the molds shown in FIGS. 5A-5D may be modified to account for the substrate member 14. For example, first mold portion 52 may include a cavity 60, schematically shown in phantom in FIGS. 5A-5D, for forming substrate member 14. In this way, when the first curable material is injected into the mold 50 the substrate member 14 and connector body 24 are integrally molded to form a unitary structure. The sealing gasket 40 is then molded onto the connector body 24 in the second shot of the molding operation in essentially the same manner as that described above.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of Applicant's general inventive concept.

What is claimed is:

1. A connecting member for securing a trim assembly to a support of an automobile, comprising:
a connector body having a first end adapted to couple to the trim assembly and a second end adapted to couple to the support, said connector body having a first hardness; and
a sealing gasket integrally molded with said connector body, said sealing gasket having a second hardness less than the first hardness and adapted to form a seal between the connecting member and the support when the trim assembly is coupled thereto.

2. The connecting member of claim 1, wherein said connector body is formed from polypropylene.

3. The connecting member of claim 2, wherein said sealing gasket is formed from a thermoplastic elastomer.

4. The connecting member of claim 1, wherein said sealing gasket is formed from a thermoplastic elastomer.

5. An automotive interior trim assembly for coupling to a support in an automobile, comprising:
a substrate member generally providing structural support for the trim assembly, said substrate member having a front surface adapted to face the interior of the automobile and a back surface adapted to face opposite the front surface; and
a connecting member coupled to the back surface of said substrate member, said connecting member comprising:
a connector body having a first end coupled to said substrate member and a second end adapted to couple to the support, said connector body having a first hardness; and
a sealing gasket integrally molded with said connector body, said sealing gasket having a second hardness less than the first hardness and adapted to form a seal between the connecting member and the support when the trim assembly is coupled thereto.

6. The trim assembly of claim 5, wherein said connector body is integrally molded with said substrate member.

7. The trim assembly of claim 5, wherein said connector body is formed from polypropylene.

8. The trim assembly of claim 7, wherein said sealing gasket is formed from a thermoplastic elastomer.

9. The trim assembly of claim 5, wherein said sealing gasket is formed from a thermoplastic elastomer.

10. A method of making an automotive interior trim assembly for coupling to a support of an automobile, the method comprising:
molding a connector body by injecting a first curable material in a first shot of a molding operation; and
molding a sealing gasket onto the connector body by injecting a second curable material during a second shot of the molding operation.

11. The method of claim 10 further comprising:
coupling the connector body to a substrate of the trim assembly.

12. The method of claim 10, wherein molding a connecting body further comprises:
molding a substrate having an integrally formed connector body by injecting the first curable material in the first shot of the molding process.

13. The method of claim 10, wherein injecting first and second curable materials comprises:
injecting a first curable material having a hardness; and
injecting a second curable material having a hardness that is relatively lower than the hardness of the first curable material.

14. The method of claim 10, wherein the first curable material is polypropylene.

15. The method of claim 14, wherein the second curable material is a thermoplastic elastomer.

16. The method of claim 10, wherein the second curable material is a thermoplastic elastomer.
